(19) United States
(12) Patent Application Publication
(10) Pub. No.: US 2003/0004892 A1
(43) Pub. Date: Jan. 2, 2003

(54) Service system

(76) Inventor: Nobuo Miyake, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/204,273

(22) PCT Filed: Apr. 17, 2002
(86) PCT No.: PCT/JP02/03823

(30) Foreign Application Priority Data
Apr. 20, 2001 (JP) 123277/2001

(51) Int. Cl. G06F 17/60

(52) U.S. Cl. 705/64

(57) ABSTRACT

The present invention realizes a highly secure service system which can readily confirm or prove that served information has been actually received by a served party. Authentication information storage means 101 stores authentication information tied to the information to be served and the authentication information is transmitted to the served party by authentication information transmitting means 102. Upon receipt of the authentication information from the served party, service determining means 103 matches the authentication information with the authentication information stored in authentication information storage means 101 to determine successful service of the information to be served. Detailed information presenting means 104 presents the information to be served on a web page accessed by the served party if the authentication information matches.

### TECHNICAL FIELD

The present invention relates to a service system for use in dispute resolution procedures.

In this specification, dispute resolution procedures refers to all procedures for resolving a dispute between parties involved in a dispute and includes, but is not limited to, court proceedings, arbitration procedures, conciliation procedures, trial procedures, procedures in alternative dispute resolution (ADR), and procedures leading to decisions, administrative dispositions, and the like in administrative agencies. Also, the service in this specification refers to the action taken in a dispute resolution procedure by a serving party (i.e., a dispute resolution organization or a service organization trusted by the dispute resolution organization, the party concerned, other interested parties, or their agents) to notify a served party (i.e., a dispute resolution organization or a service organization trusted by the dispute resolution organization, the party concerned, other interested parties, or their agents) of information connected with the dispute resolution procedure. Further, the serving party and served party are not limited to the parties involved in a dispute, but include interested third parties such as persons authorized to receive notices of legal actions.

### PRIOR ART

In a conventional dispute resolution procedure, service is made on a served party by simply notifying the served party of the information to be served via mail, facsimile, telephone, electronic mail, or hand-delivery by a person in charge of the service (for example, a bailiff or a court clerk).

However, when service is made by simply notifying the served party of the information to be served, a problem arises in that it is difficult to confirm or prove that a served party has actually received the notification unless the served party takes action after receipt of the notification, such as returning an acknowledgement of receipt indicating that the notification was received.

### SUMMARY OF THE INVENTION

It is an object of the present invention to provide a service system which is capable of readily confirming that information to be served has been actually received by a served party, i.e., readily confirming or proving the fact of service.

To achieve the above-mentioned object, the present invention provides an Internet service system for use in dispute resolution procedures, comprising:

authentication information storage means for storing authentication information tied to the information to be served;

authentication information transmitting means responsive to a transmission request from a serving party to transmit the authentication information to a served party;

service determining means for receiving input of the authentication information by the served party to match the entered authentication information with the authentication information stored in the authentication information storage means; and

detailed information presenting means for presenting the information to be served on a web page accessed by the served party if the service determining means successfully matches the authentication information,

characterized in that the authentication information transmitting means transmits the authentication information together with response prompting information to prompt the served party to input the authentication information to the service determining means.

In one embodiment of the service system of the present invention, the response prompting information is information that explicitly requests the served party to input the authentication information to the service determining means. In another embodiment, the response prompting information is information that implicitly prompts the served party to input the authentication information to the service determining means. In a further embodiment, the response prompting information is set forth in an HTML file which includes a link to a web page. The response prompting information is encrypted and transmitted.

In another embodiment of the present invention, the dispute resolution procedure is an arbitration procedure, and the information to be served is an electronic document for use in the arbitration procedure.

In a yet another embodiment of the present invention, information received by the service determining means from the served party is encrypted.

In another embodiment of the present invention, the detailed information presenting means is configured to further present information on case records associated with a case to which the information to be served is associated.

### BRIEF DESCRIPTION OF THE DRAWINGS

FIG. 1 is a block diagram generally illustrating a notice of arbitration service system for use in an arbitration procedure in one embodiment of the present invention;

FIG. 2 is a hard copy showing an exemplary display of an electronic mail transmitted by an authentication information transmitting means in a notice of arbitration service system for use in an arbitration procedure in one embodiment of the present invention;

FIG. 3 is a hard copy showing an exemplary display of an electronic mail transmitted by an authentication information transmitting means in a notice of arbitration service system for use in an arbitration procedure in one embodiment of the present invention; and

FIG. 4 is a hard copy showing an exemplary display of an electronic mail transmitted by an authentication information transmitting means in a notice of arbitration service system for use in an arbitration procedure in one embodiment of the present invention.

### BEST MODE FOR CARRYING OUT THE INVENTION

One embodiment of a service system according to the present invention, taken as an example, will be described in connection with a notice of arbitration service system for use in an arbitration procedure.

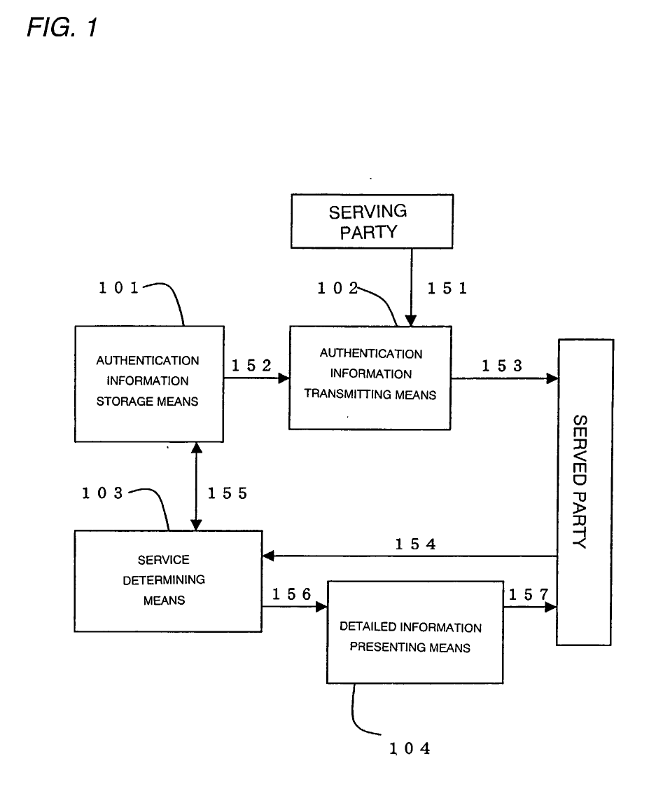

FIG. 1 is a block diagram generally illustrating a notice of arbitration service system of an arbitration organization, together with terminals used by a serving party and a served party. An outline of the service system will be described below with reference to FIG. 1. Authentication information storage means 101 is a system for storing authentication information tied to the information to be served, and is a system for outputting authentication information to authentication information transmitting means 102 (152).

In this embodiment, information to be served refers to information contained in a notice of arbitration. Specifically, this is information such as the names, addresses and/or electronic mail addresses of the concerned party and his attorney, a summary of the claim, specification of the arbitration clause or arbitration agreement, specification of the contract giving rise to the dispute, etc., which are required to be specified in a notice of arbitration in accordance with arbitration rules.

An ID consisting of a string, such as eight alphanumeric characters, and a password are used as the authentication information. A served party may personally change the password though he is not allowed to change the ID. Alternatively, a personal identification number composed of numbers, a bar code, or the like may be used as the authentication information rather than a password. The ID and password are stored on a magnetic disk and are tied to the information to be served. While a magnetic disk is herein used as the storage means, other storage means may also be used, such as memory, a magneto-optical disk, etc.

Tying the information to be served to the authentication information can be accomplished by assigning unique key data to the information to be served, storing a set of the key data, ID, and password on the magnetic disk, and referencing a region of a file which stores the information to be served using the key data. While the file which stores the information to be served is provided external to authentication information storage means 101, it may be provided internal to authentication information storage means 101. A served party number, assigned to each arbitration case, is used as the key data. For example, a combination of symbols and numbers such as “H13-48394-29384” may be used as the served party number. On the other hand, arbitrary data can be used for the key data, such as a number, a string, hexadecimal data, etc. Alternatively, a set of information consisting of the name of the party concerned, case name, date created, etc., written on the notice of arbitration may be used as the key data.

Authentication information transmitting means 102 refers to a system for receiving a transmission request from a serving party (151), receiving authentication information from authentication information storage means 101 (152), and transmitting to a served party the authentication information and response prompting information to prompt the served party to input the authentication information to the service determining means (153).

In this embodiment, a transmission request from the serving party to authentication information transmitting means 102 is made by input of a served party number tied to the information which the serving party wishes to serve (151).

Authentication information transmitting means 102 transmits the ID and password corresponding to a particular served party number to the served party (153). Authentication information transmitting means 102 also transmits to the served party response prompting information to prompt the served party to enter the ID and password to service determining means 103 (153). While the transmission of the ID and password is typically performed simultaneously with the transmission of the response prompting information, the transmissions may be shifted in time up to the extent that the served party can still understand the correspondence of the ID and password to the response prompting information. Alternatively, different transmitting means may be used such that the ID and password are transmitted via facsimile, while the response prompting information is transmitted via electronic mail.

Used as response prompting information is information to prompt the served party to make a response using the ID and password. For example, the information “X Ltd. Co. has registered a claim for arbitration against you with Y Arbitration Association. Please access http://www.XXXXX.or.jp and use the ID and password described above to respond thereto.” is sent via electronic mail. The electronic mail can be embedded with a link to a web page for inputting information to service determining means 103. While this embodiment uses an electronic mail transmitting means to transmit the ID, password, and response prompting information, a facsimile transmitting means, postal transmitting means (for example, an HTML file transmitting means for creating an HTML file which describes the ID, password, and response prompting information for transmission to a hybrid mail service site on the Internet), or the like may be used. The use of the facsimile transmitting means or postal transmitting means is preferred because security is improved in the transmission of the ID and password. Further, since all communications between a client computer of a served party and a server of this system can be encrypted using SSL (Secure Socket Layer), secure communications can be implemented. As a practical example, authentication information transmitting means 102 initially transmits the ID and password only once, and the party concerned can change the password, so that the ID and password are less susceptible to leakage.

Rather than information explicitly requesting a response to service determining means 103, information to implicitly prompt a response to service determining means 103 may be used as the response prompting information. For example, the message “X Ltd. Co. has registered a claim for arbitration against you with Y Arbitration Association. You can see details by accessing http://www.XXXXX.or.jp and using the ID and password of which you were previously notified.” may be used.

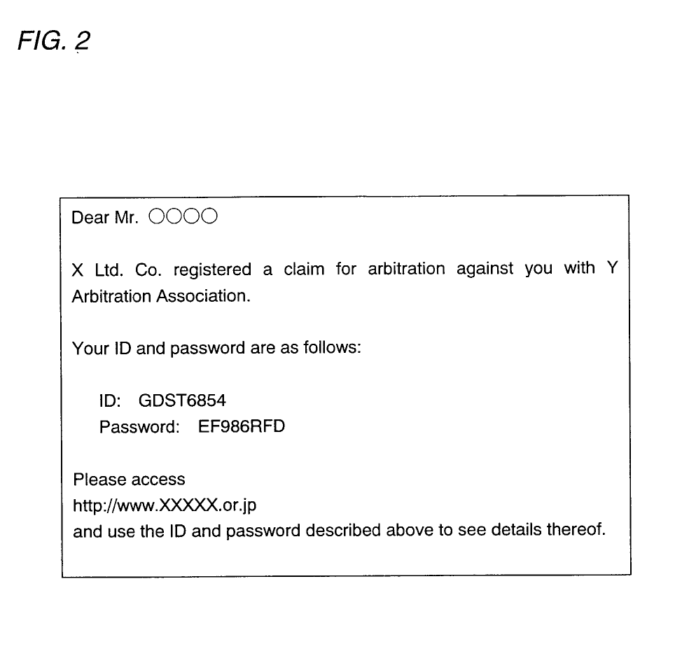

While the response prompting information may additionally include information on a response due date such as “Please respond within 14 days,” and other information, the response prompting information is preferably kept shorter with the intention of encouraging the served party to seek more detailed information out of curiosity. A specific exemplary description of the response prompting information is contained in FIG. 2 which shows an exemplary display of an electronic mail setting forth the transmitted ID and password together with the response prompting information.

Service determining means 103 is a system which receives authentication information inputted by the served party (154) and matches the inputted authentication information with the authentication information stored in authentication information storage means 101 (155) to determine whether or not the service is successful. The result of the matching by service determining means 103 is output to detailed information presenting means 104 (156).

In this embodiment, service determining means 103 is a web server installed on an Internet server and is a system which transmits an input form via a web browser to the client computer of a served party for input of the served party's ID and password (154), accesses the magnetic disk of authentication information storing means 101 to match the inputted ID and password with IDs and passwords stored therein (155), and outputs a signal indicative of successful matching to detailed information presenting means 104 if the matching is successful (156).

Here, access to information stored in authentication information storage means 101 by service determining means 103 is accomplished by installing service determining means 103 on the same computer as authentication information storage means 101 enabling it to share the magnetic disk. Alternatively, the magnetic disk can be read by service determining means 103 as needed through a line such as that provided by a LAN.

Matching of the inputted ID and password with the stored IDs and passwords is performed by searching a storage region containing the IDs and passwords to determine whether or not there are is an ID and password which matches those that were inputted.

When matching is successful, service determining means 103 outputs a signal indicative of the successful matching to detailed information presenting means 104 (156).

Detailed information presenting means 104 is a system for receiving a signal indicative of successful matching from service determining means 103 (156) and displaying information to be served on a web page accessed by the served party (157). In this embodiment, detailed information presenting means 104 is a web server that transmits information concerning a notice of arbitration to be served on a served party in an HTML file format to the client computer of the served party.

Besides the information to be served, detailed information presenting means 104 can display to the served party information on case records associated with a case to which the information to be served is associated. In other words, the served party can view a variety of allegations and evidence submitted with respect to the case, information regarding the progress of the case, etc.

In the foregoing manner, the served party is presented with the information to be served. Since this includes the information necessary to constitute service in accordance with arbitration rules, the service to the served party will have been completed. The fact of service is preserved as evidence together with the date and time the inputted authentication information was served. Therefore, the served party cannot deny the fact of service. Also, the serving party can confirm the fact of service if such fact is transmitted to the serving party.

When service is made by notifying the served party of the information to be served, the content of the notice is capable of interception by a third party other than the served party through theft of postal mail, tapping of telephone lines, etc. Particularly, in recent years, petitions, pleadings, offers of settlement, etc., are served via electronic mail through the Internet by arbitration and other organizations, so that the information to be served is highly susceptible of being leaked to a third party. In this embodiment, however, security is improved because all communications between the server and client are encrypted using SSL when information is transmitted to the client computer of the served party in HTML file format, and details are only displayed after confirming the served party's ID and password.

FIGS. 2 to 4 are hard copies showing exemplary displays of electronic mails transmitted by the authentication information transmitting means in a notice of arbitration service system for use in an arbitration procedure in one embodiment of the present invention.

FIG. 2 is an exemplary description of standard response prompting information. This example indicates the arbitration applicant and arbitration organization in order that the served party will become aware that a request for arbitration has been made. The electronic mail is embedded with a link to a web page which the served party accesses.

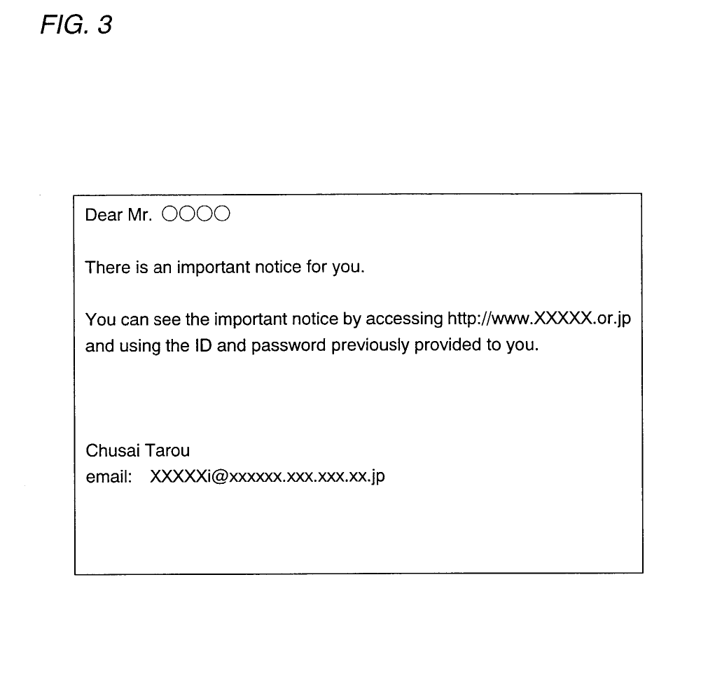

FIG. 3 is an exemplary description of relatively short response prompting information. This example does not indicate the arbitration applicant or arbitration organization, so the served party will not know anything about the content of the arbitration. In addition, the ID and password are not stated in the electronic mail. The response prompting information indicates that the ID and password have been separately sent via facsimile.

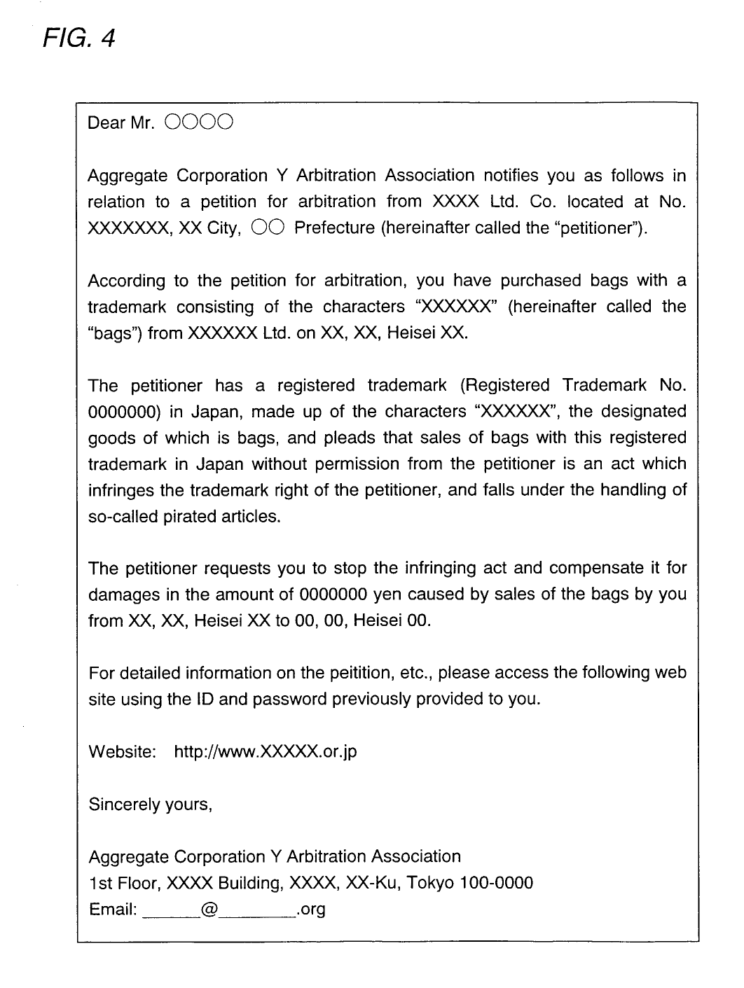

FIG. 4 is an exemplary description of relatively long response prompting information. This example sets forth a summary of the petition for arbitration in addition to the arbitration applicant and arbitration organization, but does not give detailed reasons for the petition, does not include documentary evidence, etc. The served party will be aware of the summary of the arbitration petition, but will not know the details thereof.

The foregoing exemplary displays are merely illustrative, and a variety of information including graphical information may be displayed as well.

This notice of arbitration service system for use in an arbitration procedure is merely one embodiment of the present invention, and can be modified without departing from the scope and spirit of the invention. For example, the service system can be applied to other procedures associated with an arbitration procedure and to dispute resolution procedures other than arbitration. It can also be applied to information to be served other than a notice of arbitration (for example, including, but not limited to, applications, complaints, answers, pleadings, briefs, apologia, amendments, summaries of arguments, decisions, awards, petitions of appeal, documentary evidence, appraisals, digitized records of the examination of witnesses, and objects of inspection of computer programs).

As is apparent from the foregoing description, the present invention can provide a service system which readily confirms or proves that information to be served has been actually received by a served party, i.e., the fact of service. The present invention also makes possible a highly secure service system where transmitted information is less susceptible to interception by third parties if all communications between a client computer of a served party and a server of this system are encrypted using SSL (Secure Socket Layer).

1. A service system for use in dispute resolution procedures, comprising:
authentication information storage means for storing authentication information tied to the information to be served;
authentication information transmitting means responsive to a transmission request from a serving party to transmit to a served party said authentication information, and response prompting information for prompting the served party to view the information to be served using said authentication information;
service determining means for receiving input of said authentication information transmitted to the served party to match said entered authentication information with the authentication information stored in said authentication information storage means; and
detailed information presenting means for presenting said information to be served on a web page accessed by the served party if said service determining means successfully matches the authentication information.

2. A service system according to claim 1, wherein said response prompting information is information explicitly requesting the served party to enter said authentication information to said service determining means.

3. A service system according to claim 1, wherein said response prompting information is information implicitly prompting the served party to enter said authentication information to said service determining means.

4. A service system according to any one of claims 1-3, wherein said response prompting information is transmitted with encryption.

5. A service system according to any one of claims 1-4, wherein said dispute resolution procedure is an arbitration procedure, and said information to be served is an electronic document for use in said arbitration procedure.

6. A service system according to any one of claims 1-5, wherein said response prompting information is set forth in an HTML file which includes a link to a web page.

7. A service system according to any one of claims 1-6, wherein information received by said service determining means from the served party is encrypted.

8. A service system according to any one of claims 1-7, wherein said detailed information presenting means further presents information on case records associated with a case to which the information to be served is associated.
